(19) United States
(12) Patent Application Publication
(10) Pub. No.: US 2008/0229063 A1
(43) Pub. Date: Sep. 18, 2008

(54) Processor Array with Separate Serial Module

(75) Inventors: Richard P. Kleihorst, Kasterlee (BE); Anteneh A. Abbo, Eindhoven (NL); Vishal Choudhary, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/065,536

(22) PCT Filed: Sep. 4, 2006
(86) PCT No.: PCT/IB2006/053102

§ 371 Date: Mar. 3, 2008

(30) Foreign Application Priority Data
Sep. 5, 2005 (EP) 05108126.3

(51) Int. Cl. G06F 15/76; G06F 9/30

(52) U.S. Cl. 712/30; 712/E09.016

(57) ABSTRACT

A processor array has processor elements (2) and a memory (4), connected in parallel to the accessible in parallel by the processor elements (2). A separate serial module (30) provides additional functionality for example in the form of a look up table module (30). The serial module (3) processes lines of data input to the module (30) serially. Processing can continue in the processor elements (2) in parallel using suitable programming steps.

The invention relates to a processor array, particularly but not exclusively a Single Instruction Multiple Data (SIMD) data processor array, with a separate serial module, particularly but not exclusively a look up table (LUT) module, as well as to a method of operation of a processor array and a computer program for operating the processor array.

In a SIMD processing array, each of a number of processing elements (PEs) receives the same instruction from a common instruction stream, and executes the instruction based on data unique to that processing element, which data may be termed local data. Such a processing array is suitable for highly repetitive tasks where the same operations are performed on multiple items of data at the same time, which may occur for example in the field of image processing.

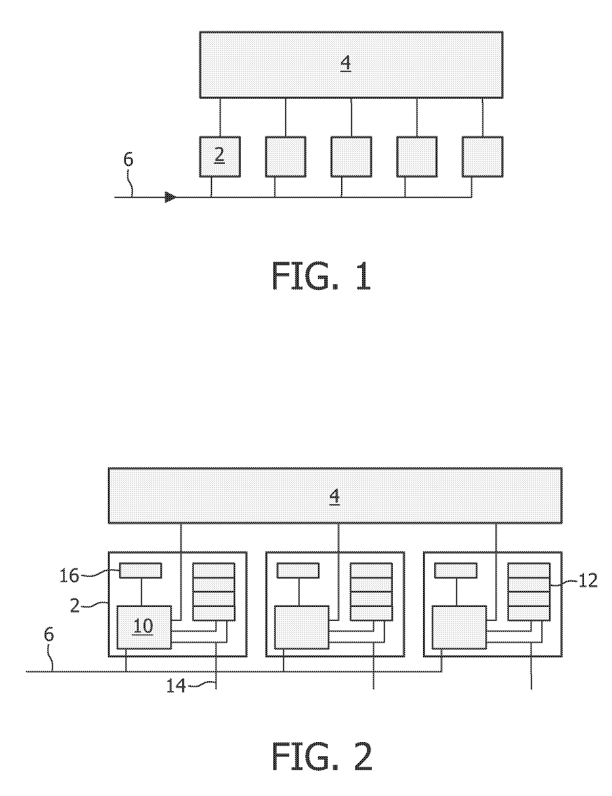

FIG. 1 shows a classical SIMD array with a plurality of processing elements 2 and a memory 4 shared by the elements. An instruction input 6 provides instructions in parallel for all processing elements, that is to say all elements carry out the same instruction. The elements do however access different data in the memory 4 in parallel.

A SIMD processing array is not however particularly efficient where the processing operations are data dependent, for example when carrying out a look up table operation. In such a case, if the look up table is stored in memory 4, each processor may require access to different parts of the memory at the same time which reduces performance because of attempted sequential access. Therefore, in some architectures, especially SIMD architectures, look up table operations are functionally computed, which can require a very large number of instructions.

One approach addressing this problem is described in U.S. Pat. No. 6,665,768 (Redford). In this approach, a single memory bank is accessed by multiple processors. However, this has the disadvantage that multiple copies of a look up table are stored in multiple banks of memory. The multiple banks of memory can be accessed in parallel by processing elements. Each processing element has an identifying value that can select one of the banks, hence improving speed.

An improved processing array for processing look-up tables is described in WO2005/017765 (Philips). A simplified version of this processing array is illustrated in simplified form in FIG. 2. Each processing element 2 has an arithmetic logic unit 10 and plurality of storage elements 12 dedicated to that processing element 2. The processing element has a coefficient input 14 and a common instruction input 6, together with an internal accumulator 16. Each processing element also includes various multiplexers, and an arithmetic logic unit, which have been omitted from FIG. 2 for simplicity.

A data item can be stored in one of the storage elements 12 of a processing element 2 by supplying a suitable instruction on the instruction input and an index on the coefficient input, to store the data in the accumulator in the storage element indexed by the coefficient input 14. Conversely, data can be loaded into the accumulator from a storage element indexed by the coefficient input. The data from the storage element 12 indexed by the coefficient input 14 can also be multiplied with the data in the accumulator 16.

A number of alternative ways of loading the correct data into the storage elements for look up table operation are described in WO2005/017765. After the data is loaded, the data in the accumulator 16 can be used as an index to select the one of the storage elements and to output the data stored in the corresponding storage element, either directly or to an internal register.

Accordingly, the processing array of WO2005/017765 can operate in three ways. Firstly, each processing element can execute the same instruction on the local data based on a broadcast instruction, as for a normal array device. Secondly, each processing element can execute the same instruction on the local data but with a different coefficient supplied on the coefficient input. Thirdly, each processing element can execute a function determined in a look up table. The processing array of WO2005/017765 can therefore provide the benefits of SIMD processing with improved performance in data dependent processing operations.

However, the provision of a local memory for each processing element as in the arrangement of FIG. 2 uses up far more silicon area than a conventional wide memory spanning more processors as in the arrangement of FIG. 1. Further, this increased complexity requires more overhead in each processing element, such as address decoders.

This complexity means that SIMD devices with indirect addressing can be rather expensive.

Further, in the particular case of a parallel look up table operation, it is necessary to store the look up table in the storage memory of each of the processing elements. In practice, it is not possible to provide enough storage locations for each of the processing elements to allow large look up tables to be stored.

The same problems can occur with other types of additional processing added to parallel processing arrays.

Accordingly, there remains a need for an improved parallel processing array for providing additional functionality.

According to the invention there is provided a processor array, comprising:

a plurality of processor elements for processing lines of data in parallel;

a memory accessible in parallel by the plurality of processor elements;

a serial module with a serial input and output for conducting a processing operation on a line of data input at the serial input to modify the line of data and outputting the result as a modified line of data on the serial output; and

means for providing a line of data from the processor elements and memory serially to the serial module serial input and for returning the modified line of data to the processor elements and memory from the serial output after the processing operation.

The serial module may be a look up table module.

In embodiments, the means for providing a line of data is a direct memory access controller connected to the serial input and serial output for directly accessing a line of data in the memory and for storing the results of the processing operation directly in the memory so that the module can carry out the processing operation while processing continues in the processing elements.

In an alternative embodiment, the means for providing a line of data includes a shift register unit including at least one shift register, the shift register unit having a serial output and a serial input, the serial input being connected to the serial output of the serial module and the serial output being connected to the serial input of the serial module, wherein the memory can access data in the shift register unit in parallel.

The processor array may in particular be a single instruction set multiple data (SIMD) processor array.

Alternatively, the invention may be applied to other multiple processor arrangements, including for example a multiple instruction set multiple data (MIMD) processor array, or very long instruction word (VLIW) processor operating in a lockstep mode.

In another aspect the invention relates to a method of operation of a processor array having a plurality of processor elements, a memory accessible in parallel by the plurality of processor elements, and a serial module, the method comprising:

processing a line of data using the plurality of processor elements;

during the processing of a line of data in the processor elements, transmitting serially the next line of data from the processing elements and memory to the serial module;

carrying out a processing operation on the next line of data in the serial module to generate a modified next line of data;

returning the modified next line of data from the serial module to the processing elements and memory; and

repeating the steps to process each line of data in turn using the processor elements in parallel with carrying out the processing operation on the next line of data in the serial module.

This implements pipelined operation.

In another aspect the invention also relates to computer program code arranged to cause a processor array having a plurality of processor elements, a memory accessible in parallel by the plurality of processor elements, and an additional serial module to execute a method as set out above.

For a better understanding of the invention, embodiments will be described, purely by way of example, with reference to the accompanying drawings, in which:

FIG. 1 shows a prior art SIMD array,

FIG. 2 shows a further prior art SIMD array;

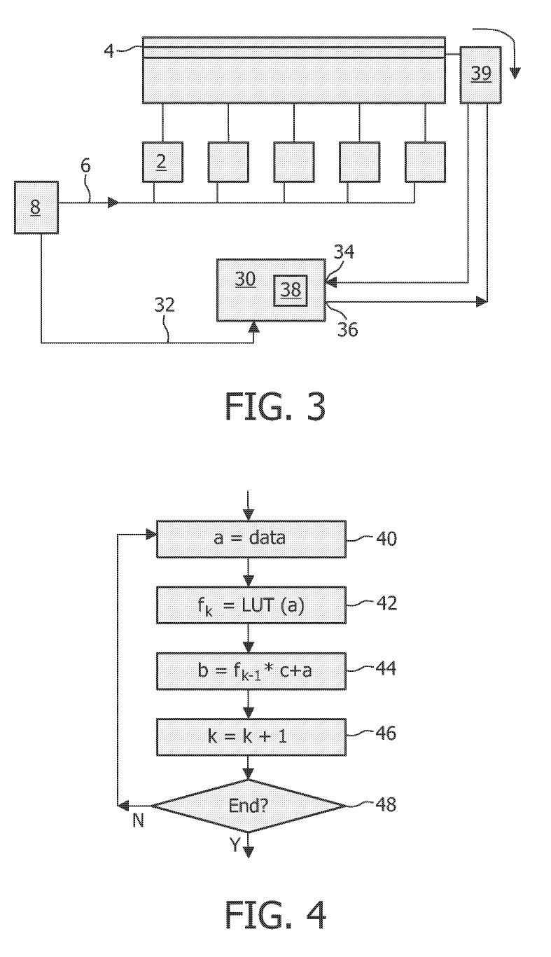

FIG. 3 shows a processor array according to a first embodiment of the invention;

FIG. 4 shows a flow chart of a method using the processor array of FIG. 3;

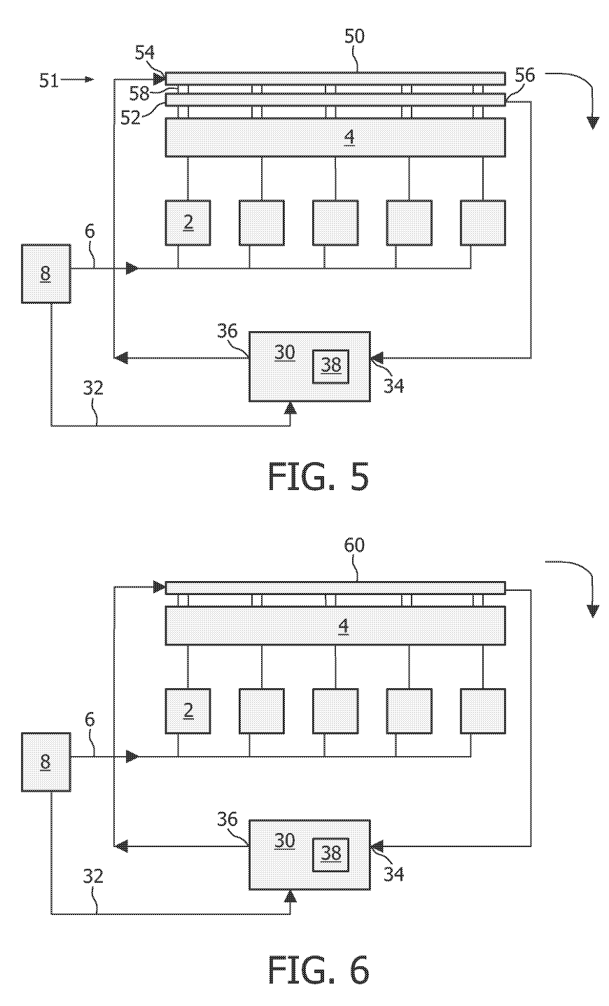

FIG. 5 illustrates an alternative embodiment; and

FIG. 6 illustrates a further alternative embodiment.

Referring to FIG. 3, a processor array according to the invention includes a plurality of processor elements 2, a memory 4 accessible in parallel by each of the processor elements, and a common instruction input 6. These features are similar to those of the prior art arrangement illustrated in FIG. 1. The number of processor elements will be referred to as N in the following, where N is a positive integer greater than 1.

A central controller 8 is provided for controlling the processor array.

A serial module in the form of a look up table module 30 is provided, with direct access to memory 4 via a direct memory access (DMA) controller 39 connected to the memory 4 and to a serial data input 34 and a serial data output 36 of the look up table module 30. A control input 32 is provided. A look up table memory 38 within the look up table module 30 is provided for storing one or more look up tables.

The look up table module 30 is controlled on control input 32, receives data on serial data input 34 and outputs processed data on output 36. The central controller 8 provides the instructions to the processor and to the look up table module. The central controller can instruct the storage of a new look up table in the look up table memory 38.

The look up table module 30 is arranged to receive a line of data serially on serial data input 34, to carry out a look up table operation to result in a modified line of data and to output that modified line of data serially on output 36. In the embodiment, the line of data is directly obtained from memory 4 by direct memory access, i.e. independently of the processors.

Typically, a line of data will include N pieces of data, one for each of the processor elements. It will be appreciated that the look up table module is operating serially on the data, whereas the processor elements are operating in parallel. Thus, typically, assuming the look up table module can carry out the look-up operation on one piece of serially input data in a clock cycle, the look up table module will require N clock cycles to carry out a look up table operation on the N pieces of data making up a line.

It might at first be thought that such a delay would be prohibitive, especially in situations where the number of parallel processors and accordingly the number of items of data in a line of data is large.

However, using suitable techniques, the processing of the look-up table operation may be seen as a single instruction to the programmer, as will now be explained.

FIG. 4 illustrates a method of operating the processor array, for a plurality of lines of data represented as data vectors a, b and f(c). A loop carries out the processing for each line of data in turn, where k represents the loop index. All operations, apart from the look up table operation, are carried out in parallel by the processing elements 2.

For each iteration round the loop, each processor element takes a piece of data a in parallel (step 40). Each processor will take a different item of data, creating an effective line of data with N data elements, one for each processor element 2.

The next step (step 42) is to carry out a look up table operation on the kth line of data. This is programmed as a simple look up table operation on the line of data as shown. This step causes the look up table module to start processing the line of data using a direct, serial data access on the memory not involving the processor elements.

Rather than waiting for the N clock cycles for this serial look up table operation to continue, the next step (step 44) is to carry out further processing of the results of the look up table operation on the previous line of data (k−1). Although only one calculation step is illustrated, there may in practice need to be a number of calculation steps on the result of the look up table operation.

Index k is then incremented (step 46) and the loop continued until all lines of data have been processed (step 48).

Note that the clocks of the processor array and look-up-table can be completely different, further aiding to decrease the delay.

Thus, the method illustrated in FIG. 4 renders the significant delay of the serial look up table operation invisible and the look up table operation will appear to the programmer as though it only takes a single clock cycle.

It will be appreciated by those skilled in the art that some details have been omitted from FIG. 4 for simplicity. For example, for the first cycle, step 44 will not be carried out since there is no previous line of data, and for the last cycle, step 40 is not required.

The processor array of FIG. 3 and method of FIG. 4 is accordingly particularly suitable for image processing, which typically requires the processing of multiple lines of data sequentially, carrying out the same operations on each line of data in turn, using a look up table operation as one of the processing steps.

Unlike arrangements with memory associated with each processor element for carrying out look-up table operation, only one copy of the look up table is required, in memory 38, and this does not need to be painstakingly loaded into the memories of each processing element 2. Thus, the memory and hence the look up table can be as large as required, without including unnecessary overhead in arrangements where only a small look up table is required.

By providing a separate element to carry out the look up table operation serially, only a single look up table is required. In the prior approach of U.S. Pat. No. 6,665,768, in which each processor accesses a different bank of memory, it is not possible for more than one processor to access the whole of the look-up table at once, so multiple copies may be required. Further, U.S. Pat. No. 6,665,768 uses the individual processor elements for the look up table operation and this is likely to take a number of clock cycles to access the large external memory, delaying the processing.

Further, by providing a separate look up table module, this can be optimised for look up table operation without compromising the conventional, rather different operation of the processor elements.

In a variation of this embodiment element 30 does not carry out a look up table operation but is a serial module arranged to carry out some alternative form of processing.

The element 30 may itself include a processor, which may be run at any suitable clock speed not necessarily the same as the processor elements 2 in view of the serial input and output. The module 30 may for example carry out Huffman, arithmetic or run-length coding. The module 30 may also be, for example, a conditional access module.

A further embodiment is illustrated with respect to FIG. 5.

In this arrangement, a DMA device is not used to access memory 4. Instead, a pair of shift registers are used, as a shift register unit 51. The shift register unit 51 includes a first shift register 50 with parallel output and serial input, and a second shift register 52 with a parallel input and serial output. The serial input 54 of the first shift register 50 is connected to the output 36 of the look up table module 30, and the serial output 56 of the second shift register is connected to the input 34 of the look up table module 30. In the embodiment, each shift register 50,52 has N positions where N is the number of processors 2.

The parallel ports 58 are addressed within the address space of memory 4 and accordingly seem, to the programmer, as normal line memories.

A similar arrangement using a single shift register 60 is illustrated in FIG. 6. The shift register 60 has a serial input 54 and serial output 56, the serial output 56 is connected to the input 34 of the look up table module and the serial input 54 to the output 36 of the look up table module. The contents of the shift register 60 can be addressed in parallel by memory 4.

It will be appreciated that the embodiments of FIGS. 5 and 6 may also be used with an alternative serial module instead of the look up table module.

The embodiments allow many different kinds of serial processing, including look up table operation. For example, look up table operation can be an efficient way of calculating some functions, such as sin( ), arctan( ) and sqrt ( ), so the embodiment allows the ready inclusion of these functions into the often simple processors used in parallel processing. The embodiment may also be used for real time video processing.

Those skilled in the art will realise that many variations to the embodiments described are possible. For example, those skilled in the art will realise that other approaches to access the data of a line than direct memory access are possible.

The number of processing units can be adjusted and it is not necessary to have the same number of processor elements as shift register positions.

1. A processor array, comprising:
a plurality of processor elements for processing lines of data in parallel;
a memory accessible in parallel by the plurality of processor elements;
a serial module with a serial input and output for conducting a processing operation on a line of data input at the serial input to modify the line of data and outputting the result as a modified line of data on the serial output; and
means for providing a line of data from the processor elements and memory serially to the serial input and for returning the modified line of data to the processor elements and memory from the serial output after the processing operation.

2. A processor array according to claim 1 wherein the serial module (30) is a look-up table module, a look up table operation, a Huffman, arithmetic or run-length coding module, or a conditional access module for allowing conditional access to data.

3. (canceled)

4. A processor array according to claim 1 wherein the processor array is arranged:
to process each line of data in turn using the plurality of processor elements in parallel; and
during the processing of a line of data in the processor elements, to carry out the processing operation on the next line of data in the serial module, so that the modified line of data is returned before the processor elements require the modified line of data.

5. A processor array according to claim 1, wherein the processor array is arranged to process a plurality of lines of data by:
determining a kth line of data for look up table operation;
instructing a processing operation on the determined kth line of data;
processing the results of the processing operation carried out on the previous (k−1)th line of data; and
repeating the determining instructing and processing steps until all lines of data have been processed.

6. A processor array according to claim 1 wherein the means for providing a line of data is a direct memory access controller for directly accessing a line of data in the memory and for storing the results of the processing operation directly in the memory, wherein the direct memory access controller is connected to the serial input on the serial module and also connected to the serial output on the serial module so that the serial module can carry out a processing operation on a serially input line of data while processing continues in the processing elements.

7. A processor array according to claim 1 wherein the means for providing a line of data includes a shift register unit including at least one shift register, the shift register unit having a serial output and a serial input, the serial input being connected to the serial output of the processing table module and the serial output being connected to the serial input of the serial module, wherein the memory can access data in the shift register unit in parallel.

8. A processor array according to claim 1 wherein the processor array is a single instruction set multiple data processor array.

9. A method of operation of a processor array having a plurality of processor elements, a memory accessible in parallel by the plurality of processor elements, and a serial module, the method comprising:
processing a line of data using the plurality of processor elements;
during the processing of a line of data in the processor elements, transmitting serially the next line of data from the processing elements and memory to the serial module;
carrying out a processing operation on the next line of data in the serial module to generate a modified next line of data;
returning the modified next line of data from the serial module to the processing elements and memory; and
repeating the steps to process each line of data in turn using the processor elements in parallel with carrying out the processing operation on the next line of data in the serial module.

10. A method according to claim 9 wherein the processing further comprises:
for each kth line of data in turn,
determining (40) a kth line of data for serial processing;
instructing (42) a serial processing operation on the determined kth line of data;
processing the results (44) of the serial processing operation carried out on the previous (k−1)th line of data; and
repeating the determining, instructing and processing steps (46,48) until all lines of data have been processed.

11. A method according to claim 9 wherein the processing operation is a look up table operation, a Huffman, arithmetic or run-length coding operation, or a conditional access operation for allowing conditional access to data.

12. (canceled)

13. (canceled)

14. (canceled)
